(19) United States
(12) Patent Application Publication
(10) Pub. No.: US 2016/0114501 A1
(43) Pub. Date: Apr. 28, 2016

(54) Method and apparatus for handling in-mold labels

(71) Applicants: David E. Carson, Fort Collins, CO (US); Jack E. Maze, Fort Collins, CO (US); Helge Steg, Tyreso (SE)

(72) Inventors: David E. Carson, Fort Collins, CO (US); Jack E. Maze, Fort Collins, CO (US); Helge Steg, Tyreso (SE)

(73) Assignee: CBW Automation, Inc.

(21) Appl. No.: 14/121,844

(22) Filed: Oct. 22, 2014

(51) Int. Cl. B29C 31/00; B65H 16/00; B65H 20/02; B26F 3/00; B25J 11/00; B65H 35/00; B65H 35/04; B29C 49/24; B65H 23/26

(52) U.S. Cl. CPC B29C 31/008; B29C 49/24; B65H 16/00; B65H 20/02; B65H 23/26; B25J 11/00; B65H 35/0006; B65H 35/04; B26F 3/002; B29C 2049/241

(57) ABSTRACT

A blank non-adhesive label stock roll containing a continuous blank non-adhesive label sheet is printed as it is being unrolled to provide a multiplicity of pre-printed labels thereon. As the label sheet is being unrolled, each of the printed labels is partially cut along a peripheral edge thereof to leave a plurality of spaced apart uncut ties joining points along the peripheral edge to a scrim area of the label sheet to thereby maintain removable attachment of each of the pre-printed labels to the scrim area. Following printing and partial cutting of the labels, the label sheet is rerolled to form a pre-printed and pre-cut label stock roll, which is then controllably unrolled to permit selective removal of the pre-printed and pre-cut labels by an apparatus that conveys them for use in an external molding process.

### BACKGROUND AND SUMMARY OF THE INVENTION

This invention relates generally to in-mold labeling of plastic containers and, more particularly, to an apparatus and process for printing, cutting, and feeding in-mold labels to an external molding process.

In the prior art, in-mold labels are typically printed on rolls of label stock, then rerolled and transported to a molding site, where the printed label roll is unrolled and cut to size for insertion into a mold. Cutting the labels by means of an expensive rotary die cutter, for example, positioned at each molding machine, is an operation that molding companies do not normally perform. Therefore, skilled operators must be hired to cover all 24-hour molding operations.

In accordance with the illustrated preferred embodiment of the present invention, an apparatus and process for use in an in-mold labeling application utilizes a roll of label stock or web material containing a multiplicity of pre-printed non-adhesive labels. The labels are partially cut from the pre-printed roll, leaving only a few uncut peripheral ties by which each of the partially cut labels remains attached to the label stock. The label stock, with the pre-printed and partially cut labels still attached thereto, is then rerolled. The resulting roll is unrolled at the molding site to permit the labels to be easily pulled from the web material against the slight resistance offered by the ties. Advantageously, the present apparatus and process eliminates the need for expensive label cutting machinery and skilled operators at each molding machine. Label cutting will instead be performed at print shops where experienced operators are already present.

### BRIEF DESCRIPTION OF THE DRAWINGS

FIG. 1 is a schematic representation of the apparatus for handling in-mold labels of the present invention.

FIG. 2 is a detailed pictorial diagram of the apparatus for handling in-mold labels of FIG. 1.

FIG. 3 is a detailed pictorial diagram illustrating the sheet unwinding and lateral justification sections of the apparatus for handling in-mold labels of FIGS. 1 and 2.

FIG. 4 is a detailed pictorial diagram illustrating the pinch roll section of the apparatus for handling in-mold labels of FIGS. 1 and 2.

FIG. 5 is a detailed pictorial diagram illustrating the servo-driven conveyor section of the apparatus for handling in-mold labels of FIGS. 1 and 2.

FIG. 6 is a flow chart of the electronic control steps implemented in and executed by a conventional electronic controller to control the apparatus for handling in-mold labels of FIGS. 1 and 2.

### DESCRIPTION OF THE PREFERRED EMBODIMENT

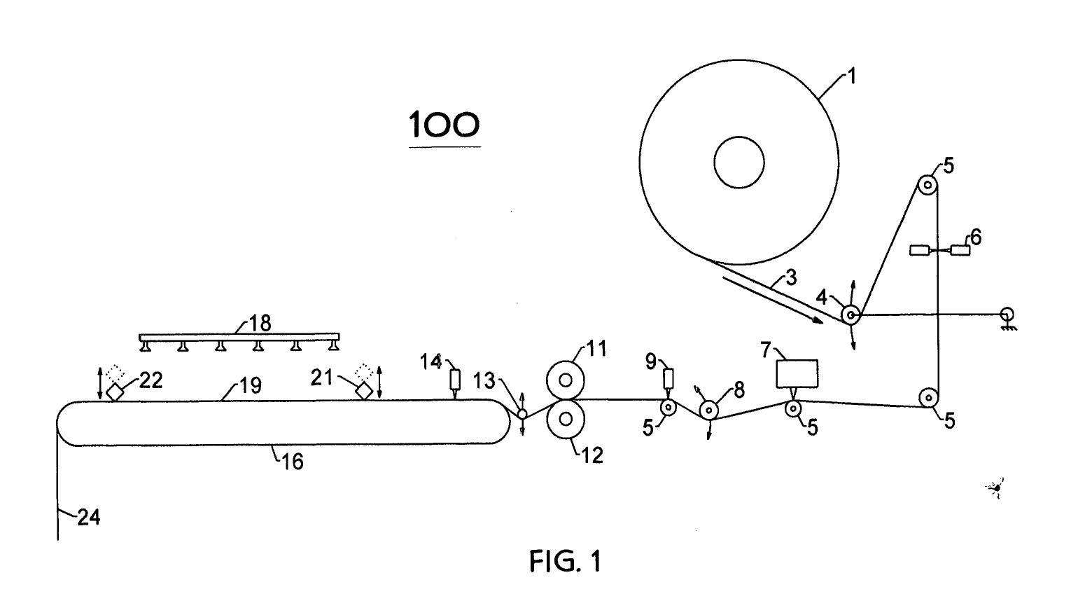

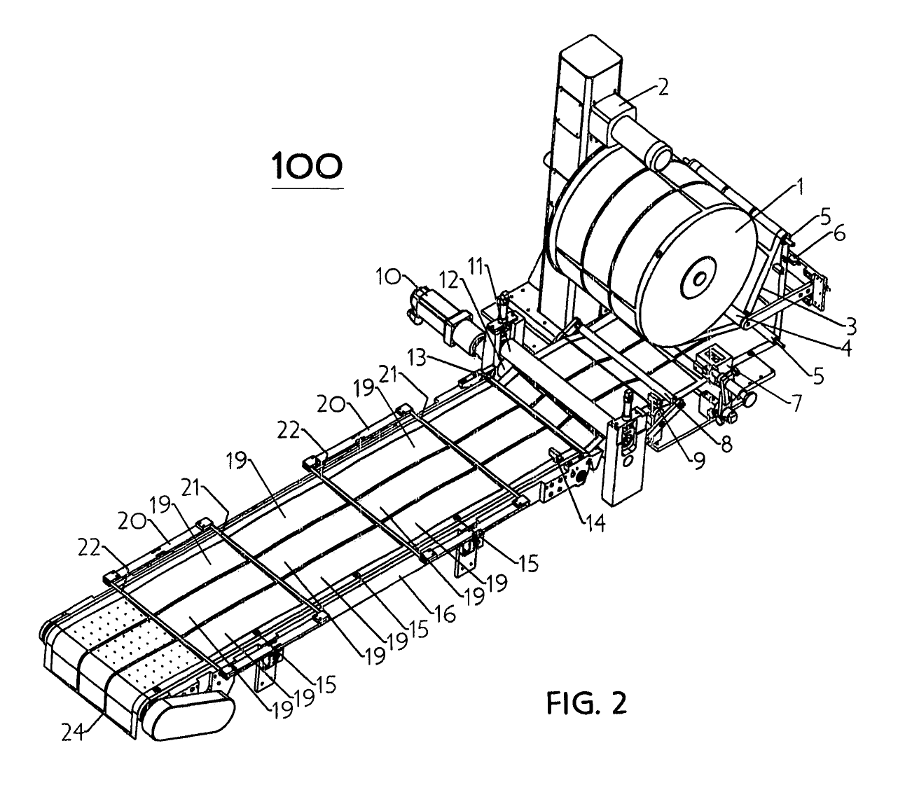

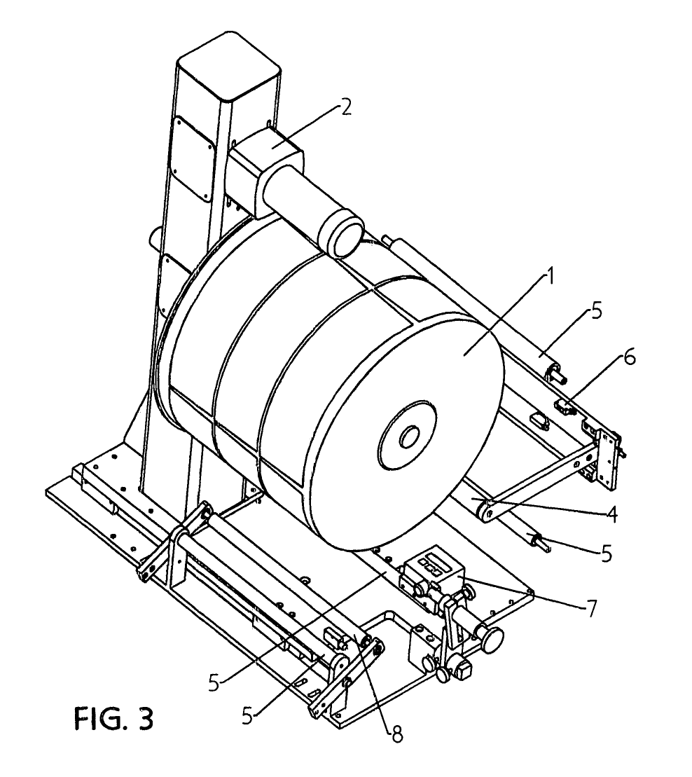

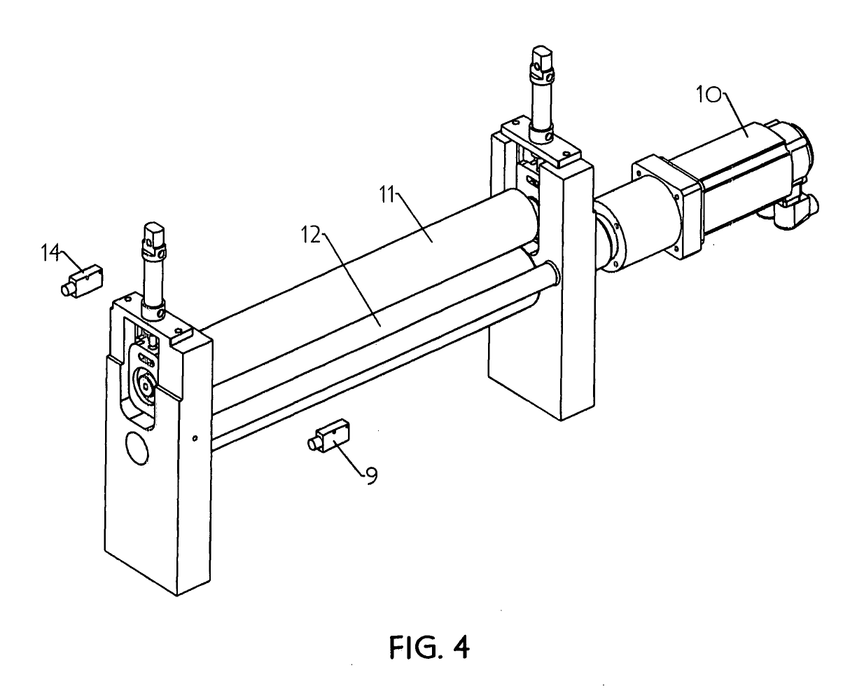

Referring now generally to FIGS. 1 and 2 and, for the details thereof, to FIGS. 3-5, there is shown an apparatus 100 for handling in-mold labels in accordance with the present invention that includes a label stock roll 1 containing a continuous label sheet 3 having one or more longitudinal lanes of non-adhesive labels or sets of labels 19 conventionally pre-printed thereon at predetermined spacing intervals. A distinguishing feature mark 15 is also pre-printed in association with each of the labels or sets of labels 19. At the time of pre-printing the labels 19 on label sheet 3, each of the labels 19 is partially cut by conventional means to a final label shape, leaving a plurality of uncut ties or tabs along the peripheral edge of each label by which each of the partially cut labels 19 remains attached to the waste portion or scrim of label sheet 3. Label sheet 3 containing the preprinted and partially cut labels 19 is then rerolled to form label stock roll 1 for use by the apparatus 100 of the present invention.

In use, rerolled label sheet 3 is unrolled from label stock roll 1 by means of a conventional servo motor 2, the free end of label sheet 3 being routed around a series of rolls, the first of which is an active float roll 4 that serves primarily to maintain constant tension in the label sheet 3 and that also serves to provide feedback for controlling the speed of servo motor 2. A plurality of rolls 5 serve as idler rolls. Label sheet 3 passes an optical sensor 6 positioned adjacent one of rolls 5 that is capable of detecting a splice in label sheet 3 to enable the in-mold labeling apparatus 100 to respond to detection of a splice in a chosen manner that prevents interruption of the flow of cut labels at the output thereof. An optical sensor 7, positioned downstream from optical sensor 6 adjacent another one of rolls 5, serves to resolve a distinguishing feature, such as a pattern or print, on label sheet 3 in order to laterally justify those patterns or prints to a set of pinch rolls 11, 12, illustrated in FIGS. 1, 2, and 4. Label sheet 3 then passes beneath a passive float roll 8 which serves as a secondary means for maintaining constant tension in label sheet 3. A sensor 9, positioned adjacent another one of rolls 5, serves to detect distinguishing feature mark 15 for the purpose of aligning label sheet 3 in a predetermined position longitudinally with respect to a set of pinch rolls 11, 12. Sensors 6, 7, and 9 may comprise conventional photoelectric sensors or one or more cameras.

Label sheet 3 is routed downstream from sensor 9 between a set of pinch rolls 11, 12 that are driven by a servo motor 10. Pinch rolls 11, 12 impart a sufficient clamping force to convey label sheet 3 from the idler rolls 5 to a conveyor 16 positioned downstream from pinch rolls 11, 12. Conveyor 16 may be a conventional vacuum conveyor or a conventional belt conveyor. Conveyor 16 is driven by a servo motor 23 and is horizontally positioned to receive label sheet 3 at the output of pinch rolls 11, 12. Before entering conveyor 16, label sheet 3 is routed beneath a passive float roll 13 that is positioned between pinch rolls 11, 12 and the input end of conveyor 16. A downward force applied to passive float roll 13 serves to create a controlled loop in label sheet 3 for maintaining a desire tension therein as it exits pinch rolls 11, 12. This downward force may be produced by the weight of passive float roll 13 itself or by a conventional spring tensioning device, for example. The loop produced in label sheet 3 by float roll 13 permits the vacuum conveyor 16 and the pinch rolls 11, 12 to operate independently of each other, thus allowing each of them to reregister for the next index cycle without subjecting label sheet 3 to excessive tension that may result in tearing label sheet 3 itself or in tearing the tabs that connect each of the partially cut labels or sets of labels 19 from the scrim area, causing labels or sets of labels 19 to be improperly located. Thus, conveyor 16 is permitted to move while pinch rolls 11, 12 are stopped. Label sheet 3 may also be moved backward by pinch rolls 11, 12 in order to reregister label sheet 3 prior to the next index cycle performed by 7 pinch rolls 11, 12.

One or more scrim hold down assemblies 20 may be provided along conveyor 16 above label sheet 3. Scrim hold down assemblies 20 are arranged to be vertically moveable, in response to compressed gas or some other conventional actuation force, between an up position and a down position. When in the up position, scrim hold down assemblies 20 are raised a sufficient distance above label sheet 3 to permit label sheet 3 to be freely longitudinally conveyed on conveyor 16. When in the down position, scrim hold down assemblies 20 are lowered such that leading and trailing transverse bars 21, 22 thereof contact the scrim areas of label sheet 3 between longitudinally-adjacent ones of labels or sets of labels 19 to permit the partially cut labels or sets of labels 19 to be removed, either singly or in groups, by an external conventional pick and place head 18, without disturbing the scrim areas. External pick and place head 18 is actuated by vacuum or some other conventional method to lift one or more of the labels or sets of labels 19 from label sheet 3 and to place them in position for further processing, such as on mandrels within a mold, for example.

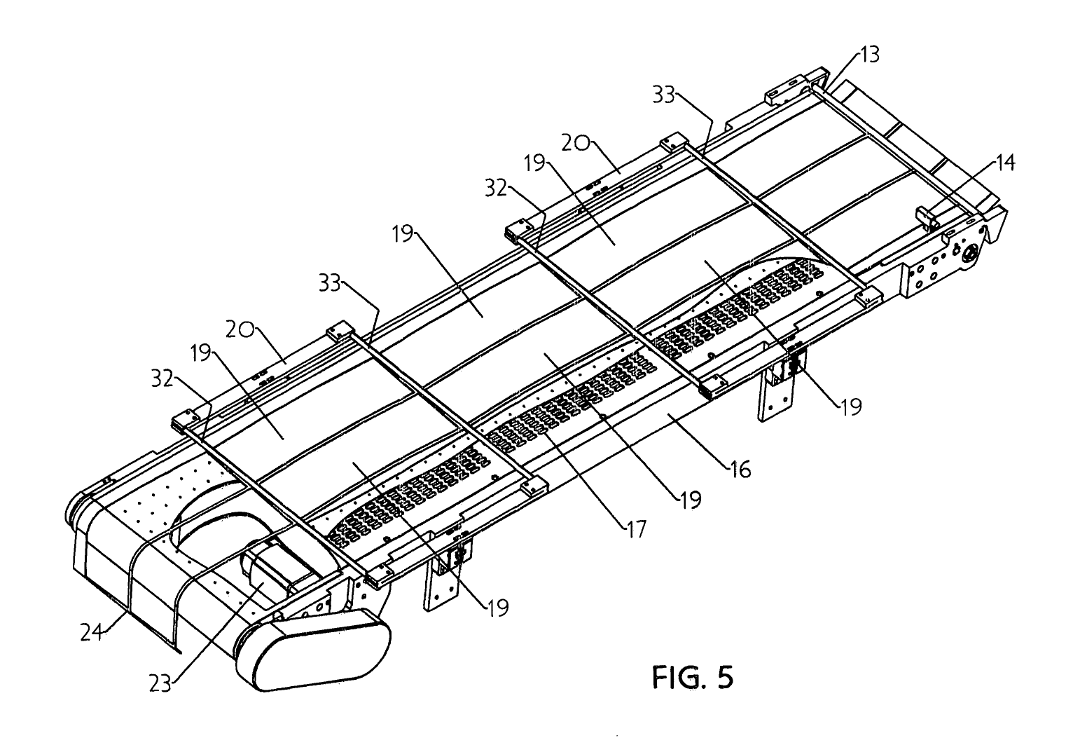

A plurality of vacuum plenums 17, illustrated in the cut away portion of FIG. 5, may be provided along conveyor 16 to selectively apply a hold-down vacuum from an external source to conveyor 16. The vacuum so applied serves to maintain label sheet 3 in a position of registration, fixed with respect to conveyor 16, while label sheet 3 is being conveyed thereon. When the label sheet 3 has been conveyed to a predetermined label removal position, vacuum previously applied to vacuum plenums 17 is released, and the cut labels or sets of labels 19 are free to be removed by pick and place head 18. An optical sensor 14, located adjacent to conveyor 16, detects each of the distinguishing feature marks 15 on label sheet 3 to facilitate alignment of the partially cut labels or sets of labels 19 in a position of registration, which is a predetermined longitudinal position obtained through precise control of the servo-driven conveyor 16. In order to locate label sheet 3 in either its position of registration or its label removal position on conveyor 16 more precisely, servo motor 23 may be controlled to restart movement of conveyor 16 at a lower speed.

Following removal of the cut labels 19 by pick and place head 18, the scrim hold down assemblies 20 are actuated to the up position, and the scrim 24 is conveyed off the end of conveyor 16 during the next operational cycle.

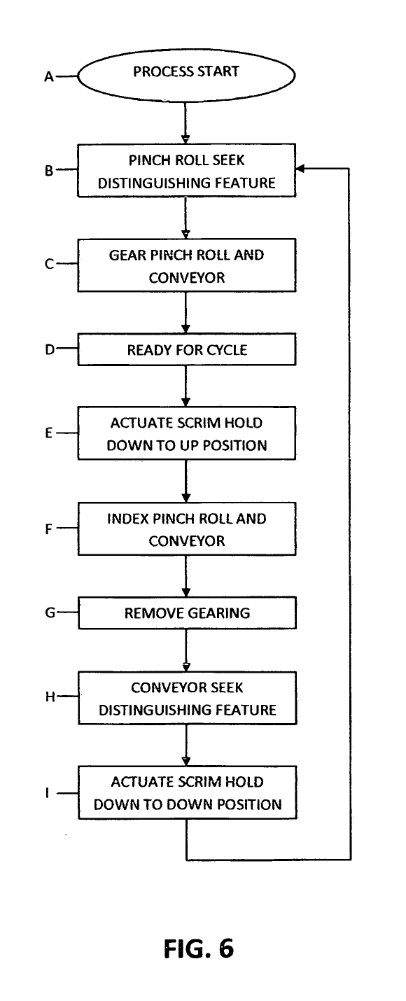

Operation of the apparatus for handling in-mold labels 100 of FIGS. 1-5 may be further understood with reference to the flow chart of electronic control steps illustrated in FIG. 6, the steps of which may be implemented in and executed by a conventional electronic controller. A process start command is issued at control step A. A Pinch Roll Seek Distinguishing Feature command is then issued at control step C to cause master servo motor 10 to rotate in the forward direction until sensor 9 has detected a distinguishing feature that serves to verify the longitudinal position of label sheet 3, following which servo motor 10 is commanded to stop rotating. A Gear Pinch Roll and Conveyor command is then issued at control step C to electronically synchronize the servo motors 10, 23 such that servo motor 10 functions as the master, and servo motor 23 functions as a slave. A Ready for Cycle command is then issued at control step D to maintain the apparatus 100 in a ready state. An Actuate Scrim Hold Down To Up

Position command is then issued at control step E to move the scrim hold down assemblies 20 to the up position. An Index Pinch Roll and Conveyor command is next issued at control step F to cause servo motors 10, 23 to rotate in the forward direction for a predetermined distance. Servo motors 10, 23 are then commanded to electronically decouple from each other at control step G, and servo motor 10 is commanded to stop rotating. A Vacuum Conveyor Seek Distinguishing Feature Mark command is then issued at control step H to cause servo motor 23 to rotate in the forward direction until sensor 14 has detected distinguishing feature mark 15 to thereby verify the longitudinal position of label sheet 3, following which servo motor 23 is commanded to stop rotating. An Actuate Scrim Hold Down to Down Position command is then issued at control step I to move the scrim hold down assemblies 20 to the down position. Following execution of control step I, electronic control of the apparatus 100 is directed back to control step B.

We claim:

1. Apparatus for use in handling in-mold labels, comprising:
a servo-driven label stock roll comprising a continuous non-adhesive label sheet having a multiplicity of non-adhesive labels pre-printed thereon and having a distinguishing feature mark associated with each of said non-adhesive labels also pre-printed thereon, each of said pre-printed non-adhesive labels having previously been partially cut along a peripheral edge thereof so as to leave a plurality of spaced apart uncut ties joining points along said peripheral edge to a scrim area of said label sheet to thereby maintain removable attachment of each of said pre-printed non-adhesive labels to said scrim area;
an active float roll for receiving a free end of said label sheet unrolled from said label stock roll, said active float roll being operative for maintaining a constant tension in said label sheet as it is being unrolled from said label stock roll and for providing feedback for controlling the rate at said label sheet is unrolled from said label stock roll;
a plurality of idler rolls positioned downstream from said active float roll for defining a path of said label sheet as it is being unrolled from said label stock roll;
one or more sensors positioned in the path of said label sheet for detecting said distinguishing feature mark preprinted on said non-adhesive label sheet to enable lateral justification and longitudinal alignment thereof;
a set of servo-driven pinch rolls positioned in the path of said label sheet for clamping the free end of said label sheet therebetween and for moving said label sheet in a selected direction;
a servo-driven conveyor positioned horizontally to receive said label sheet from said set of servo-driven pinch rolls for conveyance along said conveyor;
a plurality of vacuum plenums provided along said conveyor, a hold-down vacuum being selectively applied to said vacuum plenums from an external source for maintaining said label sheet in said position of registration on said conveyor during conveyance thereof to a predetermined label removal position, said hold-down vacuum then being released to permit removal from said non-adhesive label sheet, by an external pick and place device, of one or more of said non-adhesive labels previously partially cut from said non-adhesive label sheet; and
one or more scrim hold down assemblies positioned along said conveyor above said non-adhesive label sheet, each of said scrim hold down assemblies being vertically movable between an up position in which it is raised a sufficient distance above said non-adhesive label sheet to permit said non-adhesive label sheet to be freely longitudinally conveyed on said conveyor and a down position in which it contacts said scrim area of said non-adhesive label sheet to permit removal by said external pick and place device of one or more of said non-adhesive labels previously partially cut from said non-adhesive label sheet.

2. Apparatus as in claim 1, wherein said one or more sensors are positioned downstream from said active float roll.

3. Apparatus as in claim 1, wherein said one or more sensors comprise one or more optical sensors.

4. Apparatus as in claim 1, wherein one of said one or more sensors are positioned in the path of said non-adhesive label sheet for detecting the presence of a splice in said non-adhesive label sheet.

5. Apparatus as in claim 1, wherein said one or more sensors comprise one or more cameras.

6. Apparatus as in claim 1, further comprising a passive float roll positioned downstream from said servo-driven pinch rolls for receiving the free end of said label sheet thereunder, said passive float roll being subjected to a downward force sufficient to create a controlled loop in said label sheet for maintaining a desired tension therein as it exits said servo-driven pinch rolls, said controlled loop in said label sheet permitting operation of said conveyor independently of said servo-driven pinch rolls.

7. Apparatus as in claim 1, wherein one or more of said labels comprises one or more series of labels.

8. Apparatus as in claim 1, further comprising an additional passive float roll for maintaining a constant tension in said non-adhesive label sheet.

9. Apparatus as in claim 1, wherein each of said scrim hold down assemblies comprises leading and trailing transverse bars for contacting said scrim area of said non-adhesive label sheet when each of said scrim hold down assemblies is in said down position.

10. Apparatus as in claim 1, wherein said multiplicity of non-adhesive labels pre-printed on said non-adhesive label sheet are arranged in a plurality of longitudinal lanes across a width of said non-adhesive label sheet.

11. A process for handling in-mold labels, comprising:
providing a blank label stock roll comprising a continuous blank non-adhesive label sheet;
printing a multiplicity of non-adhesive labels on said non-adhesive label sheet as it is being unrolled from said blank label stock roll;
partially cutting each of said printed non-adhesive labels as said non-adhesive label sheet is being unrolled from said blank label stock roll, each of said printed non-adhesive labels being cut along a peripheral edge thereof so as to leave a plurality of spaced apart uncut ties joining points along said peripheral edge to a scrim area of said non-adhesive label sheet to thereby maintain removable attachment of each of said pre-printed non-adhesive labels to said scrim area;
re-rolling said non-adhesive label sheet, following printing of non-adhesive labels thereon and partial cutting of said non-adhesive printed labels, to form a pre-printed and pre-cut non-adhesive label stock roll;
controllably unrolling said pre-printed and pre-cut non-adhesive label stock roll; and
selectively removing said pre-printed and pre-cut non-adhesive labels from said pre-printed and pre-cut non-adhesive label stock roll for conveyance to a molding process.

12. A process for handling in-mold labels, comprising:
providing a blank label stock roll comprising a continuous blank non-adhesive label sheet;
printing a multiplicity of non-adhesive labels on said non-adhesive label sheet during a time that said non-adhesive label sheet is being unrolled from said blank label stock roll;
partially cutting each of said printed non-adhesive labels as said non-adhesive label sheet is being unrolled from said blank label stock roll, each of said printed non-adhesive labels being cut along a peripheral edge thereof so as to leave a plurality of spaced apart uncut ties joining points along said peripheral edge to a scrim area of said non-adhesive label sheet to thereby maintain removable attachment of each of said pre-printed non-adhesive labels to said scrim area;
re-rolling said non-adhesive label sheet, following printing of non-adhesive labels thereon and partial cutting of said non-adhesive printed labels, to form a pre-printed and pre-cut non-adhesive label stock roll;
controllably unrolling a free end of said non-adhesive label sheet from said pre-printed and pre-cut non-adhesive label stock roll;
maintaining a constant tension in said non-adhesive label sheet as it is being unrolled from said pre-printed and pre-cut non-adhesive label stock roll;
detecting one or more distinguishing feature marks pre-printed on said non-adhesive label sheet;
laterally justifying said non-adhesive label sheet based upon detection of said one or more distinguishing feature marks;
providing a set of servo-driven pinch rolls for clamping said free end of said non-adhesive label sheet therebetween and for moving said non-adhesive label sheet in a selected direction to a predetermined longitudinal position of registration with respect to said detected distinguishing feature marks;
providing a servo-driven conveyor positioned horizontally for receiving said non-adhesive label sheet and for conveying said non-adhesive label sheet along said conveyor;
moving said non-adhesive label sheet in a forward direction on said conveyor to a predetermined longitudinal position of registration;
maintaining said non-adhesive label sheet in said position of registration on said conveyor;
conveying said non-adhesive label sheet, maintained in said position of registration, to a predetermined label removal position on said conveyor;
holding down said scrim area of said non-adhesive label sheet, following conveyance thereof to said label removal position on said conveyor, to thereby enable removal, by an external pick and place device, of one or more of said pre-printed and pre-cut non-adhesive labels without removal of said scrim area; and
conveying said scrim area of said non-adhesive label sheet off of an output end of said conveyor.
